(19) United States
(12) Patent Application Publication
(10) Pub. No.: US 2010/0201308 A1
(43) Pub. Date: Aug. 12, 2010

(54) DEVICE AND METHOD FOR BATTERY CHARGING

(75) Inventor: Rune Adolf Lindholm, Sottunga (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/306,665

(22) PCT Filed: Jun. 29, 2006
(86) PCT No.: PCT/IB2006/001790

§ 371 Date: Apr. 5, 2010

(51) Int. Cl. H02J 7/00; G06F 13/00; H02J 7/04

(52) U.S. Cl. 320/107; 710/100; 320/162

(57) ABSTRACT

The invention relates to a method for detecting a charger on a serial data bus in a first device (8). The method comprises connecting (100) said first device to a second device via a serial data bus interface, measuring (104) logic voltage levels of first (D+) and second (D−) data lines of said serial data bus, and determining whether a battery (14) of said first device (8) may be charged from a power supply line (VBUS) of said serial data bus based on said measured logic voltage levels.

### FIELD OF THE INVENTION

This invention relates to the charging of battery powered equipment via a serial data bus interface.

### BACKGROUND

Many battery powered electronic devices are arranged to be connected to another device, such as a personal computer or a printer, for data communication. Some examples for such devices are handheld computers, digital cameras, or mobile phones. The connection to a PC or some other device is frequently effected via a serial data communication bus. Since the USB (Universal Serial Bus) standard is the most commonly used standard in this field, it will serve as an example for the purpose of explaining this invention, although the idea of the invention is not limited to any specific standard.

A serial data bus interface usually includes at least one data line, a ground line and a power line. Additional pins and lines may be present. In most cases a device is allowed to draw power from the power line on the interface. The purpose of this power supply is that devices with limited power consumption would not need to have an additional power supply for operation with the host device. For the case of USB, standard specification defines how much power may be consumed by a device and under what conditions power may be drawn. Usually a specific connection procedure compliant with the respective standard is required.

Although it was not originally designed for this purpose, the power line is also increasingly used to charge batteries in battery powered USB devices. However, there is currently no support for battery charging within the USB specification. In order to be able to draw power from a USB host or hub, the device needs to connect and enumerate in order to determine the allowed power level that may be drawn from the power line. Implementation of USB interface charging therefore always requires a full USB interface to be implemented within a device for communication with the host/hub. Similarly, a battery charger would have to implement the same standard or specification to communicate with the device and indicate its charging capabilities. This leads to complex and unnecessarily expensive solutions for implementing simple charging functionality with USB devices.

While the expense may be limited for a hub with charging capabilities since a hub would have to implement USB specification for bus communications in any case, it would be much less profitable for a stand-alone battery charger. It is thus desirable to find a way of integrating charging capabilities for devices having a serial data bus interface, which is simple, cost effective and does not require the implementation of complete standards such as the USB standard.

The USB specification also defines only two current levels that the host/root hub or hub must support, i.e. one unit load (100 mA) and five unit loads (500 mA). In order to charge a battery in battery powered equipment, a high current may be needed. It would thus be useful if a device charging its battery would be able to obtain information on the charging capabilities of the charger, particularly nominal and maximal current supply values. When connected to a charger which can supply much more current than the device is designed for, the device should be capable of limiting the current itself to a suitable value or of discontinuing the charging procedure. If the current capabilities of the charger match or are below the device capabilities, the device may begin charging the battery. Charging may be discontinued if the supplied current as indicated by the charger is not sufficient.

### SUMMARY

A method is provided that allows a device to determine if a charger or hub with extended charging capabilities is connected to its serial data bus interface and to subsequently start charging its battery. Furthermore, a device is provided that includes a simple and low-cost solution for implementing this method.

This is achieved by driving the data lines of the serial data bus to predetermined logic levels dependent on the type of interconnected devices. A device with charging capabilities as described in this invention is able to detect the logic voltage levels of the data lines and to determine from this information whether it is connected to a normal hub or to a special charger. With only two data lines, four different logic combinations of high and low logic voltage levels are available to distinguish a normal hub and several types of chargers, e.g. chargers with different output current characteristics. The desired logic voltage states are obtained by a set of additional pull-up and pull-down resistors that are connected to the data lines of the serial data bus in both the battery powered device and the hub or charger.

The method according to the invention comprises the steps of connecting or attaching a first device to a second device via a serial data bus interface; measuring logic voltage levels of first and second data lines of the serial data bus, and determining whether a battery of the first device may be charged from a power supply line of the serial data bus based on the measured logic voltage levels. The logic voltage levels may be high or low and allow an easy determination of a connected or attached device by predefined states.

Preferably, the first device starts to charge its battery via the serial data bus interface from the second device if at least one of the data lines is determined to have a high logic voltage level. With two data lines, three out of four states possible have at least one high line, and if such a state is detected, the device has information that a charger is attached and may start charging, e.g. by actuating a switch.

The method may further comprise connecting a first resistor between a reference voltage source and a first data line of the serial data bus, and connecting a second resistor between a reference voltage source and a second data line of the serial data bus. These resistors may then be dimensioned to achieve the desired logic voltage states. A detection method based on resistors or similar circuits is very cost effective and easy to implement.

In one embodiment, the first and second resistors are connected upon attaching the first device. It is preferred that the first and second resistors are of essentially equal resistance.

After the step of determining, a third resistor may be connected between the first data line and a reference voltage, wherein the resistance of said third resistor is less than each of the resistances of the first and second resistors. This third resistor is a small pull-up resistor for standard speed detection which may be performed after charger detection, especially when connection or attachment to a hub has been detected. This resistor may be connected to either line, dependent on the state definition for speed detection.

For load balancing reasons, the first and second resistors may be disconnected after said step of determining.

In one embodiment, the amount of current available via the serial data bus interface may be determined, based on the measured logic voltage levels of the data lines. This makes it possible to recognize current output and also enables the device to start to charge its battery only if the determined available current is within a predetermined range, which would be helpful to ensure that the battery of the device is not loaded exposed to excessive current levels, or to keep the current limited within some standardized range.

A further aspect of this invention is a method for indicating charger capabilities to a first device attached via a serial data bus interface, the method comprising driving at least one data line of said serial data bus to a high logic voltage level; supplying a predefined current on a power supply line of said serial data bus to said first device; determining the amount of current drawn by said first device; and driving all data lines of said serial data bus to a low logic voltage level if said amount of current drawn by said first device is within a certain range. This would enable a charger with hub functionality to first identify itself as a charger to an attached device and then optionally to allow normal hub data communication, if the drawn current is within a preset range.

The at least one data line may be driven to a high logic voltage level by connecting a fourth resistor between said at least one data line and ground, to achieve a termination which allows the device to pull the respective data line to a high logic level.

Similarly, the driving of all data lines to a low logic voltage level may be achieved by connecting fifth resistors between all data lines and ground, the resistance of each of said fifth resistors being less than the resistance of the at least one fourth resistor. The fifth resistances for hub identification should be lower to ensure that the lines are now pulled down. Again, for load balancing and further reasons, said at least one fourth resistor may be disconnected before connecting the fifth resistors to the data lines.

The driving all data lines to a low logic voltage level may be performed upon expiry of a predefined time period, the time period starting at the attachment of said device. This will enable a device to perform a charger detection during that time period before a combined device identifies itself as a hub.

While the described methods are not limited to this, the serial data bus according to the method of the invention is preferably operated according to USB standard. In that case, while a normal hub may only supply a maximum of five unit loads (500 mA) of current, a charger according to the invention would preferably supply a current on said power supply line that is higher than 500 mA. This would allow also high-power USB devices to charge their batteries without an additional power supply interface.

As a further aspect of the invention, a device with a serial data bus interface and a rechargeable battery is presented, comprising at least a first and a second data line, a ground line and a power supply line; first and second resistors connected between said first and second data lines and a reference voltage source; measuring means adapted for measuring logic voltage states of said first and second data lines; and a charging control means, adapted for deciding if a certain amount of current may be drawn from the power supply line, based on said logic voltage states obtained from said measuring means. Such a device is able to charge its battery with a high current when such a current is supplied, and only with a limited current if it is connected to a standard USB hub, since the device can determine by means measured voltage states whether it is attached to a charger.

The control means may be adapted to start charging said battery if at least one of said data lines is determined to have a high logic voltage state. This provides a device that only charges its battery if some type of charger is detected.

The device may further comprise a third resistor switchably connected between one of said data lines and a reference voltage, wherein the resistance of said third resistor is less than the resistance of said first and second resistors. This resistor may advantageously be used as a speed detection resistor when the device is attached to a hub, and disconnected for charger detection procedures.

A further aspect of the invention is a system comprising a first and a second device, the system including: a first and second data line, a ground line and a power supply line, connected between said first and second devices; a first and a second resistor connected between said first and second data lines and a reference voltage; wherein the termination of said data lines at said second device is configured to drive at least one data line to a high logic voltage level, and wherein said second device is capable of supplying a predetermined amount of current to said first device via said power supply line. The first device is such provided with an easy way of determining that the second device can supply a current for battery charging by means, and the second device has the interconnected data lines terminated in such a way that the first device may determine this.

Preferably, the described termination of data lines at said second device comprises at least one fourth resistor connected between one of said data lines and ground. Alternatively the data lines at the second device are left floating, which would further simplify the charger design and reduce costs. For determining the states of the connected data lines, the devices may comprise means for measuring logic voltage levels of said first and second data lines.

Another aspect of the invention is a charger for a serial data bus, the charger comprising: a serial data bus interface, including a first and second data line, a ground line and a power supply line; a fourth resistance between at least one of said data lines and ground; fifth resistors, switchably connected between all data lines and ground; and control means for connecting said fifth resistors to said first and second data lines, responsive to the amount of current drawn by an external device from said power supply line. The control means may connect the fifth resistors to enable an identification as a hub.

In one embodiment, the fourth resistance may be obtained by leaving said at least one data line floating, since a floating line has the same effect as a very large resistor connected to this line.

When said fourth resistance is present at only one of the data lines, one of said fifth resistors (R5) may be connected between the remaining (second) data line and ground for pulling the second data line to a low logic state.

The charger may further comprise timing means adapted to define a time period after which said control means is allowed to connect said fifth resistors.

### BRIEF DESCRIPTION OF THE DRAWINGS

In the following, the idea of the invention will be described in more detail by means of exemplary embodiments with reference to figures, where

FIG. 1 is a illustration of a prior art USB speed detection circuitry;

FIG. 2 shows a USB device with charging capabilities attached to a charger according to one embodiment of the invention;

FIG. 3 shows a further embodiment of the charger of FIG. 2 with a floating data line;

FIG. 4 is a flow chart of the charger detection mechanism of the invention;

FIG. 5 represents the charger output characteristics for voltage and current; and

FIG. 6 is a combined charger/hub according to the invention, attached to an USB device.

### DETAILED DESCRIPTION OF THE DRAWINGS

Serial data buses such as USB provide easy and versatile data connections between devices. Each device may connect to a hub which may have a number of downstream facing ports for several devices as well as an upstream facing port in direction of the host. A hub that is included at the host and provided with a controller, referred to as a root hub, only has downstream facing ports. Devices that do not themselves serve as hubs only provide an upstream facing port.

Currently, USB supports several data transmission rates. Low-speed USB operates at a rate of 1.5 MB/s, while full-speed USB is at 12 MB/s. The USB 2.0 specification further supports a high-speed mode of 480 MB/s. A hub or device needs to recognize the speed capabilities of a device it is connected to in order to transmit and receive signals. For this purpose, USB standard provides for a speed detection mechanism utilizing logic states of the attached data lines. A hub or host can recognize during the connection process that a certain data line, D+ or D−, is on a high logic voltage level while the other data line is pulled low. This indicates the presence of an attached device to the hub; from the voltage states detected on both data lines, a determination of the device speed is possible.

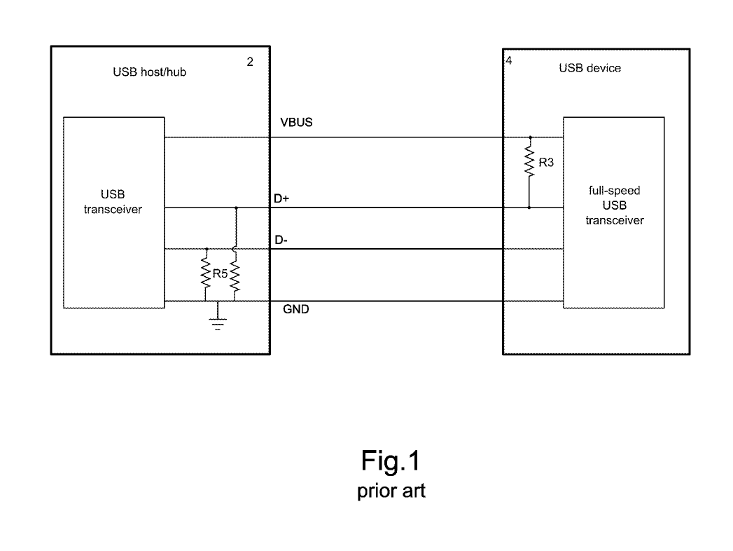

FIG. 1 presents a schematic illustration of a full-speed USB device interface with speed detection circuitry according to prior art. The USB root hub/hub 2 has pull-down resistors R5 connected between ground (GND) and the two data lines D+ and D−. These resistors are dimensioned to pull the voltage level of both data lines near ground, i.e. to a logic low state. On the downstream USB device side, a pull-up resistor R3 is connected between one of the data lines and a reference voltage. The dimension of this pull-up resistor R3 should be such that the corresponding line will be pulled to a logic high level when attaching the device 4 to a hub 2. This requires that the pull-up resistor R3 of the device be smaller than the pull-down resistor R5 on the hub side 2 of the data line. The resistance ratio of those resistors R3 and R5 may e.g. be set to around 10, but is not fixed. The only requirement is that the line will be pulled high in this constellation, and the required voltage level of a logic high state may be defined within a certain range instead of a specific value. A full-speed USB device is usually identified by a pulled-up D+ line, and a low-speed device will pull the D− line high. In FIG. 1, the resistor is connected to D+ by way of example only. Detection of high-speed capable devices (up to 480 Mb/s) may require further signals or circuitry, as described in detail in the USB specification. The speed detection pull-up resistor R3 at the device port 4 is usually switchable and will be disconnected once the speed detection process is completed to enable the line for data signalling.

According to the USB 2.0 specification, pull-down resistors R5 on the downstream facing port should be 14.75 to 24.8 kΩ, while the pull-up resistor R3 used for speed detection on the upstream facing port should be 1.5 kΩ. These values are, however, only one possibility out of a wide range and may be chosen differently when not bound to the USB standard, according to design requirements and further considerations with regard to the complete interface system.

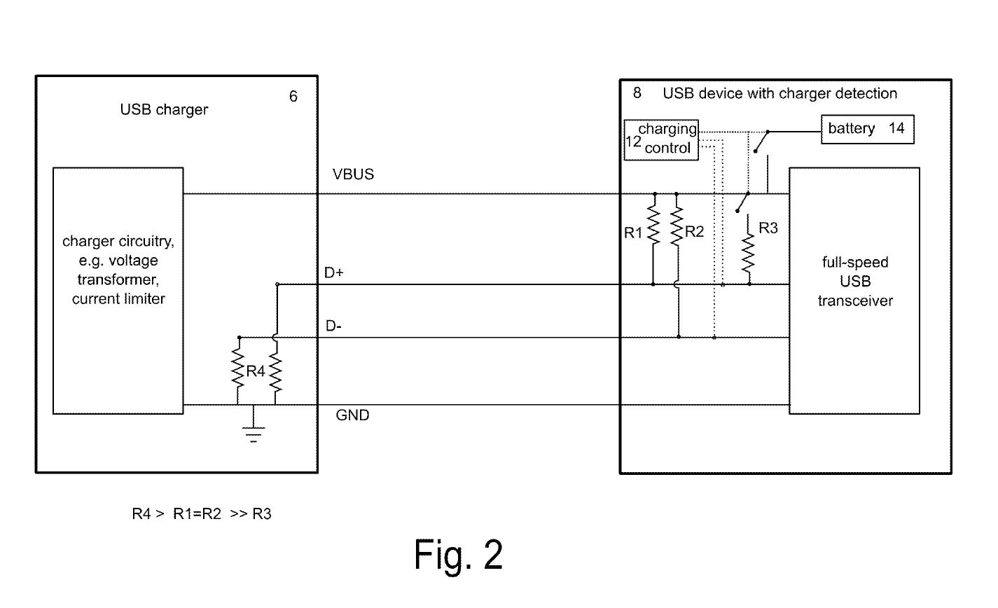

For charger detection according to the invention, additional pull-up and pull-down resistors are used. Such additional resistors are included on both the device side and the charger/hub side. Instead of pull-up and pull-down resistors, some other kind of circuitry might be utilized to achieve the corresponding logic states or voltage levels on both data lines. A first embodiment of an arrangement including a USB charger 6 and a USB device with charging capabilities 8 is shown in FIG. 2. Between a reference voltage and both data lines D+ and D−, two further resistors R1 and R2 are connected at the device interface port. The reference voltage for the pull-up resistors R1, R2 and R3 of the device may be provided by the Vbus line. The resistance value of these resistors (R1, R2) is selected such that D+ and D− are not pulled high on attachment to a normal hub 2, i.e. the resistances shall be larger than the pull-down resistances R5 of a standard hub. The USB charger 6 also has termination resistors R4 between one or both data lines D+ and D− and ground in one embodiment of the invention. These resistors R4 are such that the respective line(s) may be pulled up by a USB device with charging capabilities, that is, a USB device with further pull-up resistors R1 and R2 connected to both data lines. The termination resistor(s) R4 of a charger have to be considerably larger than the pull-up resistors of the device to ensure that the data line may be driven high on attachment. In turn, these device pull-ups R1, R2 for charger detection have to be larger than the pull-downs R5 of a normal hub to be able to distinguish between a charger and a normal hub. Altogether, this provides that all resistances used in devices, chargers and hubs would have to be related as follows:

R4>R1/2>R5>R3

The ratio between each stage of resistors could be arbitrarily set to about ten, such that the termination resistors R4 in a charger would be about a hundred times larger than the pull-down resistors of a normal hub, R5, and a thousand times larger than a pull-up resistor R3 used for speed detection on the device side. If only a single data line is provided with a large resistor R4 on a charger 6 side, the remaining data line should be pulled down with a resistor of preferably the size of a normal hub pull-down resistance R5.

As a result, a USB device with charging capability would have both lines pulled low when attached to a normal hub, since R1/2>R5, but one or both data lines pulled high when attached to a charger with R4>R1/2 on one or both lines. This enables a device to determine whether it is attached to a hub 2 and may only draw limited power after enumeration according to the USB specification, or attached to a charger 6 which may provide considerably more current. As a result of this detection mechanism, a device 8 may start charging its battery and drawing power without having to connect and enumerate before. This also eliminates the need of implementing a fully USB standard conform interface (on both sides) if it is merely intended to be used as a charging means.

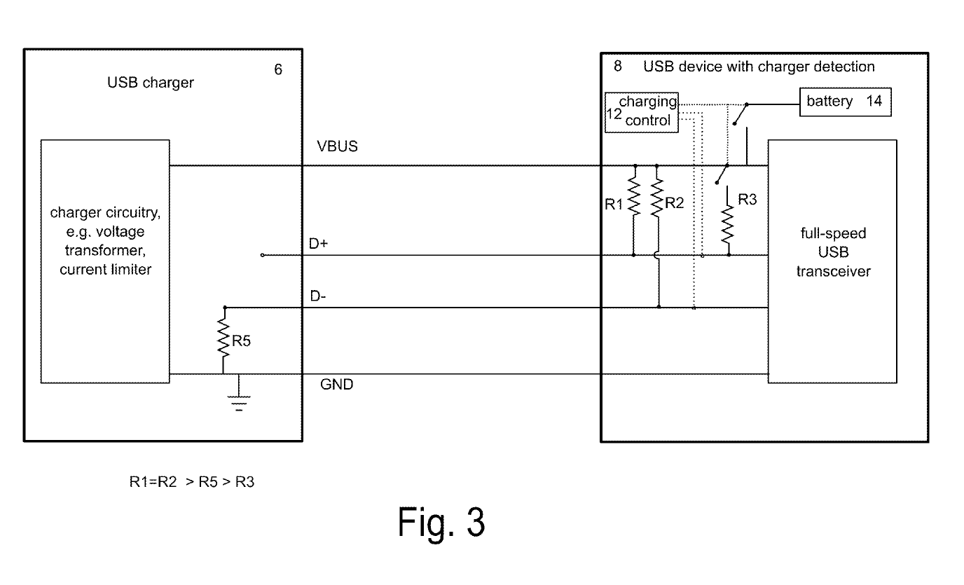

With resistance values in the range of MΩ for R4, the termination of the respective data lines is close to an open circuit. Instead of using a large resistor R4, these lines could therefore be left floating in a further embodiment of the invention. If both data lines are intended to be pulled high, this allows an even easier charger design with only two wires connected, i.e. ground and VBUS. Similarly, if only one data line should be pulled high on attachment of a device with charging capabilities, this line could be left floating instead of connecting a large resistor R4 between the corresponding data line and ground. The design of a charger would thus become even more simple and cost effective. To ensure that the respective other data line is not pulled high at the same time, this line should be pulled low, typically by a pull-down resistor having e.g. a resistance in the range of a pull-down resistor of a normal hub, R5. Such a design is shown in FIG. 3. The charger 6 as shown has one line D+ floating, which corresponds to a very high resistance termination of this data line. Due to the connection of the data line to a reference voltage via resistor R1 on the upstream device side 8, this will lead to a logic high on this line. To avoid that the second data line D− would be pulled high as well, pull-down resistor R5 is connected to ground at the downstream charger side 6 and is of less resistance than R2, such that this line is pulled low. In this embodiment of the invention, a charger would thus have either one pull-down resistor R5 on any one data line to ground and the other line floating, or no resistor at all and both lines floating, which would then lead to a high-high state for an attached device.

A charger 6 may include further elements, e.g. connectors, voltage transformers, current limiters and controllers to allow charging at various power sources, which are not shown or discussed further here.

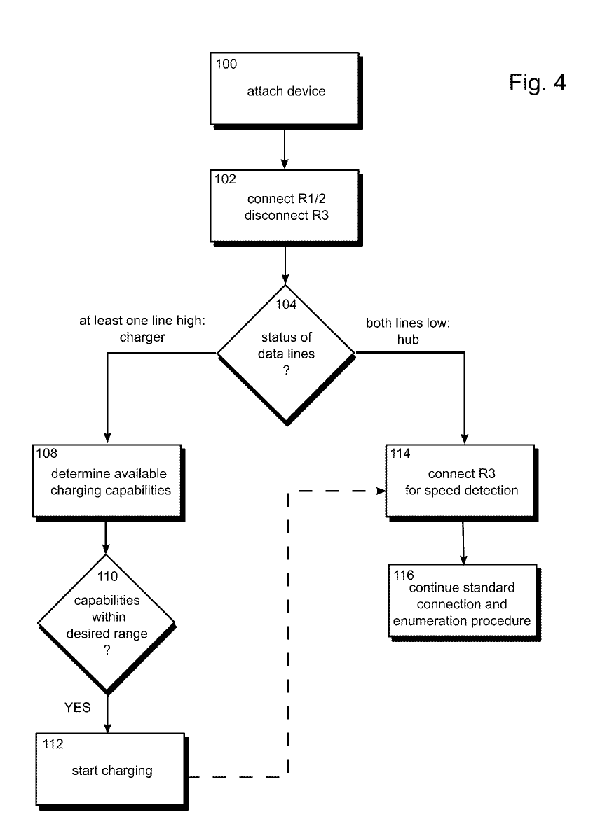

In FIG. 4, the method for charger detection in a battery powered device according to the invention is illustrated by means of a flow chart. Step 100 is the attachment of the device to a port of a yet undetermined device. At this point, the hub 2 or charger 6, 10 on the opposite side may not be aware of the attachment, since in general the connect signalling according to USB standard comprises one data line pulled high. In step 102, the device should connect the charger detection pull-up resistors R1 and R2 to both data lines. The connection may already be present, or the resistors may also be permanently connected to the data lines. It is important that the speed detection resistor R3 of the device, which will be of much lesser resistance than the charger detection resistors R1 and R2, is disconnected for the charger detection procedure, since a small resistance and a large resistance connected in parallel would lead to a even smaller combined resistance, which would distort the charger detection mechanism on connection to a normal hub 2 with relatively small pull-down resistors R5. This speed detection pull-up resistor R3 is also intended to be switchable in the current USB standard for load balancing reasons.

A measuring means of the device will then in step 104 detect the logic voltage levels of both data lines. The measuring means may be located within a charging control block 12. The exact voltage level is not relevant. High and low logic states of a data line may be defined in various ways. Usually a voltage below a certain first limit close to zero will define a low state, and a voltage range of higher value will be detected as a logic high. Values in between these states may either be used for different signalling purposes or are avoided. With two data lines, four logic combination states are obtained. When one data line or both data lines are detected to be in a high logic state, the device knows that it is connected to a charger 6 or a hub with extended charging capabilities 10.

The exact amount of current a charger provides to a device may vary. Predefined settings that may be stored in a charging controller 12 within the device would allow to determine, in step 108, how much current the charger can supply. An example of detectable charger states is given in Table 1 below. With this information, the device may also control the battery charging procedure dependent on the determined charging capabilities of the attached charger as described in the following.

TABLE 1
Exemplary charger detection states and characteristics

| state of | | | charger characteristics/ | | |
|---|---|---|---|---|---|
| data signals | | upstream | output current | | |
| D+ | D− | device type | nominal | maximum | comment |

| | | | | |
|---|---|---|---|---|
| low | low | hub/ | according to USB standard | enumeration |
| | | root hub | | required |

| | | | | |
|---|---|---|---|---|
| low | high | charger | 1 A | 1.2 A |
| high | low | charger | 1.5 A | 1.8 A |
| high | high | charger | 500 mA | 600 mA |

In one embodiment, the device may include a programmable charging control 12. The current information as detected may be checked by the charging control 12, and charging may only be started if the detected current supply values are within a certain predefined range (step 110 of FIG. 4). Charging may be started by closing a switch at some point between the battery 14 to be charged and the power supply line VBUS in step 112, with the switch selectively controlled by the charging control 12. A system with charging control is shown schematically in FIGS. 2, 3, and 6. The settings of the charging control 12 may be defined in various ways; for example, a device may only charge a battery 14 if the available charging current exceeds a current limit for a high power device. In other cases, a device may be set to only charge from a specific kind of charger as indicated by a particular data line state, or only from chargers that stay well below a critical current limit of e.g. 1 A, such that charging will be started with any charger that supports a current of 1 A or less. When the logic states detected by the device match the programmed and stored states of the charging control, the charging switch may be closed and the battery 14 of the device 8 will be charged from the USB interface power supply VBUS. The charger characteristics in Table 1 are stated as an example only, and actual current values may be different. With a serial data bus having more than two data lines, even more elaborate state detection schemes would be possible. The specific charging mechanisms and procedures once a charger has been detected and initiated correctly are not discussed any further.

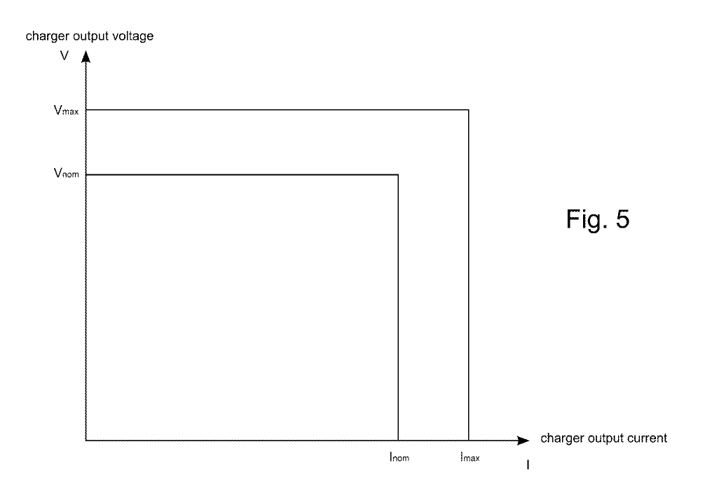

The nominal charger output current as defined in Table 1 above signifies that the charger at this load maintains the VBUS output voltage within the range as specified in the USB 2.0 specification. The maximum current as defined in Table 1 is the short circuit current of the charger. This is the maximum current the charger delivers when in constant charging mode. A USB charger supporting more than 500 mA in this example has one of the D+ or D− signals pulled down. The preferred pull down resistance is that of a normal hub port. How this pull-down is implemented is not of importance; one basic principle is that one of the data lines has a pull down resistor as e.g. illustrated in FIG. 3. In FIG. 5, the charger output characteristics are illustrated. One can see that the USB charger shall deliver the nominal output current, corresponding to Iₙₒₘ in FIG. 5 and Table 1, maintaining the VBUS voltage as specified in USB 2.0. The maximum charger output current corresponds to Iₘₐₓ. Thus, a USB device that has identified a USB charger may rely on these values, and it is ensured that the maximum charge current will not exceed the limits as indicated in Table 1. The device may draw the nominal current as specified, with the VBUS voltage keeping within the ranges of the USB specification.

Back to the flow chart of FIG. 4, the device 8 may also detect a low logic state on both lines D+ and D−. This indicates that the device is attached to a standard USB hub 2, as will be evident from the discussion of pull-up and pull-down resistors above. Therefore, the device may only draw current, for charging or any other purpose, in accordance with the specification for such a hub. For the USB standard this provides that only one unit load (100 mA) may be drawn on the VBUS line prior to the connection procedure, and not more than five unit loads of current after enumeration. To initiate standard connection and enumeration procedures (step 116), the speed detection resistor R3 needs to be connected to one of the data lines in step 114. This will lead to a logic high signal on the line the resistor is connected to, which in turn will announce the presence of a device to the hub, along with its transmission speed.

A charger may use the state of the D+ or D− signals to detect if a device that has charging capabilities has been connected. During the charger detection process the device will pull-up one or both of the D+/D− lines. This can be used by the charger to determine that it needs to supply power to the device. Prior to detection of the device, the charger may be in a quiescent mode and consume very little power from its input source. In this way, the charger detection method may also be used by the charger to enter a low power mode when there is no device to be charged connected to it. In this mode, the charger would not need to supply more than one unit load to the device. For a charger without USB communication capabilities, it would not even have to supply a minimum of one unit load prior to charger detection. This would allow the charger to have a lower quiescent current.

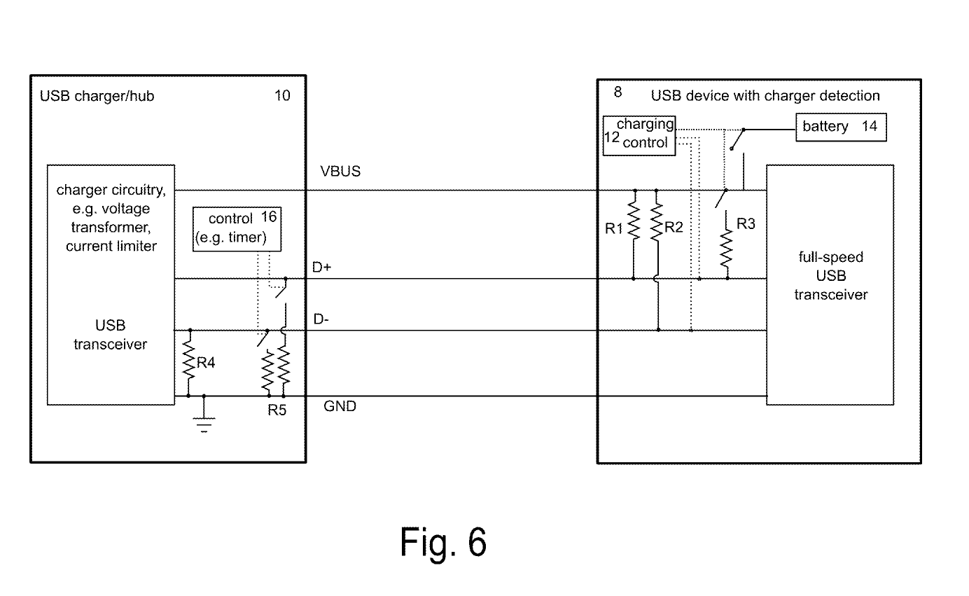

In a further embodiment of the invention, a USB charger may be combined with a hub in a single device 10. This requires a specific implementation of the hub downstream port, shown in FIG. 6. Upon attachment, the combined hub/charger 10 should at first present itself to the attached device as a charger, which means that the charger termination resistor or resistors R4 on its downstream port should be connected between a data line and ground, or alternatively the respective data line(s) should be left floating as described above for the charger embodiment as in FIG. 2. At the same time, the remaining data line should again be pulled down by a resistor such as R5 if only one line is floating or provided with a large R4. If the hub/charger 10 detects that the device is only drawing limited current which is within the range to maintain the VBUS voltage within the specifications, the hub can decide to connect both its normal port pull-down resistors R5. As a consequence, both data lines will be pulled low. If the attached device 8 is a USB supporting device and does not draw more current than allowed by the specification, it may now connect and enumerate according to standard procedures (step 116). The device may be configured to not connect the speed indication resistor until a logic low state is detected on both data lines, indicating a hub.

While in FIG. 6 a resistor R4 is present to achieve that the respective data line is pulled high when connected to a device with charging capabilities as shown, this resistor is not necessary if the line is instead left floating for charger detection. Then, it would be sufficient to selectively switch the two pull-down resistors R5, such that none or one resistor is connected for charger detection, and both resistors are connected for subsequent speed detection and possible enumeration.

The device charging from the USB power supply must disable the charger detection circuitry or ignore that the line state was changed to “hub” after the charger detection. This may be accomplished by either specifying a minimum time during which a combined hub needs to identify itself as a charger, or by disconnecting the charger detection circuitry and connecting the speed detection resistor of the device prior to starting to charge. In the latter case it would be allowed for the hub 10 to identify itself towards the device as a hub when charging current is drawn. A control circuit 16 may be included in the combined hub/charger to switch the resistor blocks accordingly. For a combined charger/hub, the standard USB attach and connect procedure may have to include an additional charger detection procedure, but would not otherwise change the connection process.

As a conclusion, the system and method of the invention provide a possibility for charging battery powered devices via a serial data bus interface without the need to implement a full hub port in the charger and/or an upstream facing port in the USB device in order to negotiate the power from the USB host port. Additionally, it is possible to detect the characteristics of a charger according to the invention during a detection procedure. Such information may be used by a device to determine whether it is safe to charge its battery on the charger. When a host/hub is detected, power consumption and potential charging may be implemented according to the USB 2.0 specifications (or any other suitable standard). The inventive method would in general not have any impact on the USB device connection process as currently employed, since the used resistors will not be able to cause a state change on the USB data lines that could be interpreted as a connection request from the device. A further implementation provides a combined charger/hub; in that case, the USB connection procedure would change slightly.

As a person skilled in the art will understand, this invention is not limited to the USB standard or to the embodiments, examples, and values used in this description and the figures. It may rather be utilized with many different kinds of serial data bus implementations, since there are no further requirements on the charger or the charging detection circuitry other than the simple mechanism of pulling data lines to high and low logic states as described. Serial buses with more than two data lines may be modified in a similar way, such that more combinations of data line states would be possible and charger detection could be refined. Also, many combinations and variations of the embodiments as described are possible without departing from the scope of the invention.

1-33. (canceled)

34. A method comprising
connecting a first device to a second device via a serial data bus interface;
connecting a first resistor between a reference voltage source and a first data line of said serial data bus, and connecting a second resistor between said reference voltage source and a second data line of said serial data bus;
measuring voltage levels of said first and said second data lines of said serial data bus; and
determining whether a battery of said first device may be charged from a power supply line of said serial data bus based on said measured voltage levels.

35. The method according to claim 34, further comprising
the first device starting to charge said battery via said serial data bus interface from said second device if at least one of said data lines is determined to have a high voltage level.

36. The method according to claim 35, wherein said first and second resistor are of essentially equal resistance.

37. The method according to claim 36, further comprising
after said step of determining connecting a third resistor between said first data line and a reference voltage, wherein the resistance of said third resistor is less than each of the resistances of said first and second resistors.

38. The method according claim 34, further comprising
after said step of determining, disconnecting said first and second resistors.

39. The method according claim 34, further comprising
determining the amount of current available via said serial data bus interface based on said measured voltage levels of said data lines.

40. The method according to claim 39, wherein said first device starts to charge said battery only if the determined available current is within a predetermined range.

41. A method comprising
allowing at least one data line of a serial data bus to be driven to a high voltage level;
supplying a predefined current on a power supply line of said serial data bus to a first device;
determining the amount of current drawn by said first device; and
driving all data lines of said serial data bus to a low voltage level if said amount of current drawn by said first device is within a certain range.

42. The method of claim 41, wherein said allowing of at least one data line to be driven to a high voltage level is achieved by connecting at least one fourth resistor between said at least one data line and ground.

43. The method of claim 41, wherein said allowing of at least one data line to be driven to a high voltage level is achieved by leaving said at least one data line floating.

44. A device having a serial data bus interface and a rechargeable battery, comprising:
at least a first and a second data line, a ground line and a power supply line;
first and second resistors connected between said first and second data lines;
a reference voltage source;
measuring means adapted for measuring voltage states of said first and second data lines and
a charging control block, adapted for deciding if a certain amount of current may be drawn from said power supply line, based on said voltage states obtained from said measuring means.

45. The device of claim 44, wherein said control means is adapted to start charging said battery if at least one of said data lines is determined to have a high voltage state.

46. The device of claim 45, further comprising a third resistor switchably connected between one of said data lines and a reference voltage, wherein the resistance of said third resistor is less than the resistance of each of said first and second resistors.
